(19) United States
(12) Patent Application Publication
(10) Pub. No.: US 2016/0361803 A1
(43) Pub. Date: Dec. 15, 2016

(54) QUICK DETACHABLE WRENCH BRAKING STRUCTURE

(71) Applicant: YEO - MING WANG, TAIPEI CITY (TW)

(72) Inventor: YEO - MING WANG, TAIPEI CITY (TW)

(21) Appl. No.: 14/738,242

(22) Filed: Jun. 12, 2015

(51) Int. Cl. B25B 23/00; B25B 13/46

(52) U.S. Cl. CPC B25B 23/0035; B25B 13/463

(57) ABSTRACT

A quick detachable wrench braking structure comprises: a wrench head, having an operation accommodation room, an acting hole is horizontally disposed in the operation accommodation room, a control hole is vertically disposed behind the operation accommodation room and is connected with the acting hole; a wrench handle, connected with and behind the wrench head; an operation device, having a pushing member and an inserting rod, the inserting rod is inserted into the control hole, the inserting rod has a positioning hole; and an urging device, having an urging rod and a flexible member, the urging rod is firmly inserted into the positioning hole, a front end of the urging rod is an urging head corresponding to the acting hole, the flexible member is in the control hole, so that an urging force is provided to the urging rod or the inserting rod.

### BACKGROUND OF THE INVENTION

### 1. Field of the Invention

The present invention generally relates to a wrench structure, more particularly to a quick detachable wrench braking structure, that is, a wrench can fast detach from a working piece after operations, and is to facilitate operations.

### 2. Description of the Prior Art

Wrenches are commonly used for operation in order to facilitate tighten, loosen a screw or nut and other kinds of positioning workpiece, and includes many different types, such as open-end wrench, combination wrench, box wrench, adjustable wrench, socket wrench, and so on. A prior wrench as shown in FIG. 1, a wrench 90 has a wrench head 91 having an accommodation room 92, an outer ring of the accommodation room 92 is disposed a rotating mechanism 93, the accommodation room 92 is to accommodate a nut 94 (or screw), etc. as a working piece to be rotated. By means of the accommodation room 92 engaging the nut 94 (or screw), the wrench 90 is rotated for applying forces in order to loosen or tighten the nut 94. As aforesaid, the prior art is able to loosen or tighten for achieving an effect of saving effort, it still has some shortcomings. For instance, the nut 94 should be withdrawn from the accommodation room 92 of the wrench 92, but normally a finger is used to push the nut 94 out from top of the accommodation room 92 due to a certain fit tightness between the nut 94 and the accommodation room 92. It seems that the prior art is inconvenient for detaching the nut 94 from the accommodation room 92. Hence, how to solve the shortcoming from the prior art becomes an important issue to those people skilled in the art.

Accordingly, the inventor has studied some related skills in order to develop a quick detachable wrench braking structure for facilitating operations, safety, stability, and convenience, so that such related technologies may be improved.

### SUMMARY OF THE INVENTION

The main objective of the present invention is to provide a quick detachable wrench braking structure, that is, an easy linking structure is able to let the wrench fast detach from a working piece to be rotated (nut, screw, etc.), in order to facilitate operations and safety.

The second objective of the present invention is to provide the quick detachable wrench braking structure, that is, an automatic recover effect after pushing while in detaching the wrench from the working piece (nut, screw, etc.) to be rotated. It is very convenient for next operation, and practicability is promoted.

The third objective of the present invention is to provide the quick detachable wrench braking structure, that is, the easy linking structure facilitates manufacturing and assembly for better economic effect.

The fourth objective of the present invention is to provide the quick detachable wrench braking structure, that is, the braking structure prevents parts being loosened, shaken or broken, so as to tremendously increase stability, operation certainty, life, and quality.

To approach above objectives, the quick detachable wrench braking structure comprises: a wrench head, having an operation accommodation room, an acting hole is horizontally disposed in a rear peripheral wall of the operation accommodation room, a control hole is vertically disposed behind the operation accommodation room and is connected with the acting hole; a wrench handle, connected with and being behind the wrench head; an operation device, having a pushing member and an inserting rod underneath, the inserting rod is inserted into the control hole, a diameter of the inserting rod is less than a length of the control hole, the inserting rod has a positioning hole corresponding to the acting hole; and an urging device, having an urging rod and a flexible member, the urging rod is firmly inserted into the positioning hole, a front end of the urging rod is an urging head corresponding to the acting hole, the flexible member is in the control hole and is behind the urging rod in order to provide an urging force to the urging rod or the inserting rod.

Accordingly, the control hole is a long hole.

Accordingly, an urging hole for disposing the flexible member is behind the control hole and is along the wrench handle.

Accordingly, the flexible member is in the positioning hole, a front end of the flexible member urges the urging rod, a rear end of the flexible member urges the urging hole.

Accordingly, a rear end of the urging rod is a positioning section that is a threaded section, the positioning hole is a threaded hole.

Accordingly, a rear end of the wrench head is disposed a pivoting slot, an open slot is disposed in a bottom edge of a rear peripheral wall of the operation accommodation room and is along the wrench handle, the open slot has a turning switch that has a pulling member above and a pulling rod under the pulling member, the pulling rod is pivotally disposed in the pivoting slot, the open slot has a ratchet member that is driven by the pulling rod.

Accordingly, the urging hole backwardly penetrates through the wrench head, a urging pillar is at a rear end of the urging hole.

Accordingly, an urging slot for accommodating the urging pillar is vertically disposed in the rear end of the urging hole, or is disposed in the rear end of the urging hole at around 90 degrees.

Accordingly, the urging rod is inserted into the positioning hole by way of tight fitting, a rear end of the urging rod is a positioning section that is in the urging hole.

Accordingly, a diameter of the positioning section is enlarged.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic view of a wrench structure in prior arts;

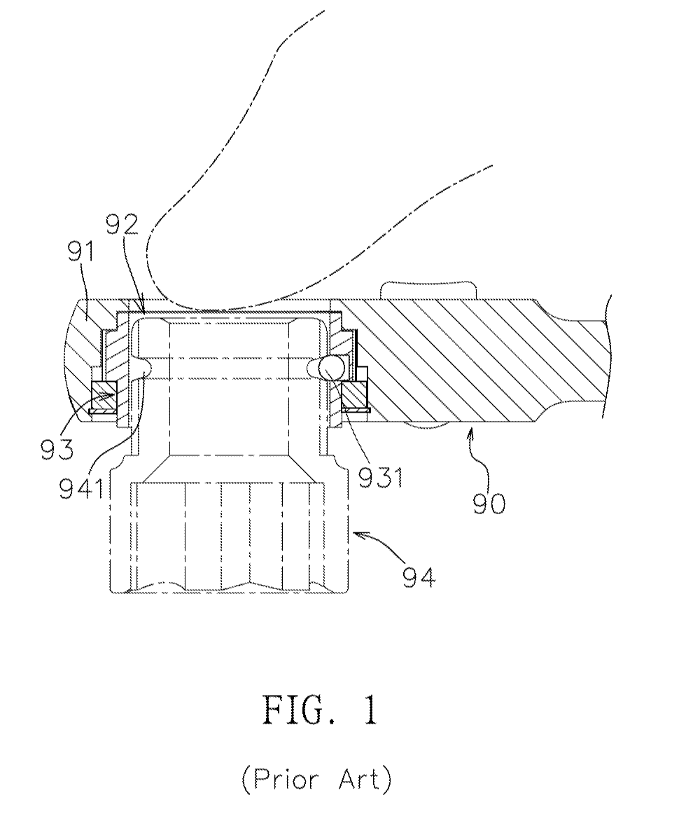

FIG. 2 illustrates a schematic exploded view of a first preferred embodiment of the present invention;

FIG. 3 illustrates a schematic integrated and sectional view of the first preferred embodiment of the present invention;

FIG. 4 illustrates a schematic sectional view of a detaching operation of the first preferred embodiment of the present invention;

FIG. 5 illustrates a schematic exploded view of a second preferred embodiment of the present invention;

FIG. 6 illustrates a schematic integrated and sectional view of the second preferred embodiment of the present invention;

FIG. 7 illustrates a schematic sectional view of a detaching operation of the second preferred embodiment of the present invention;

FIG. 8 illustrates a schematic exploded view of a third preferred embodiment of the present invention; and

FIG. 9 illustrates a schematic integrated and sectional view of the third preferred embodiment of the present invention.

### DETAILED DESCRIPTION OF THE INVENTION

Following preferred embodiments and figures will be described in detail so as to achieve aforesaid objects.

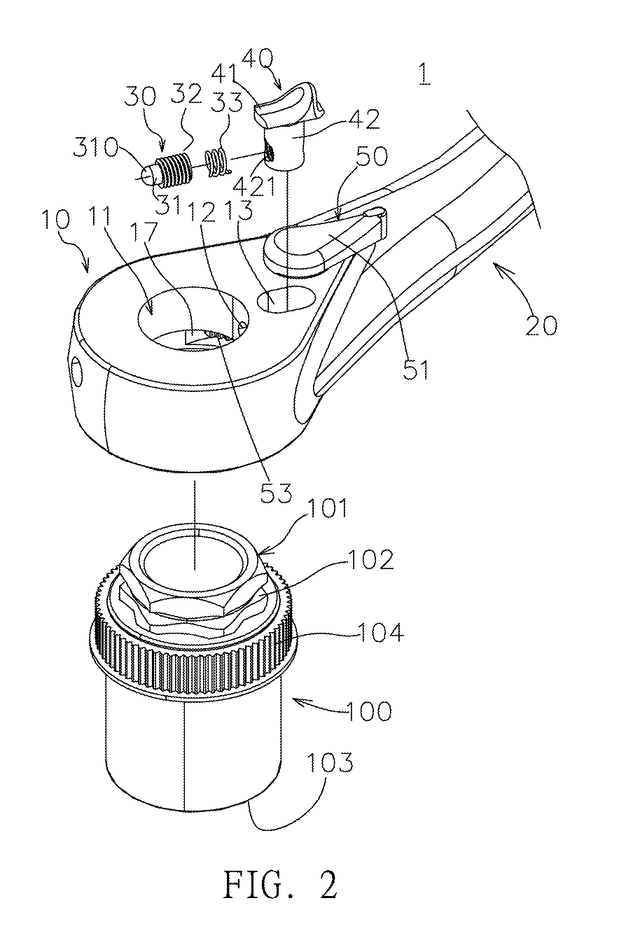

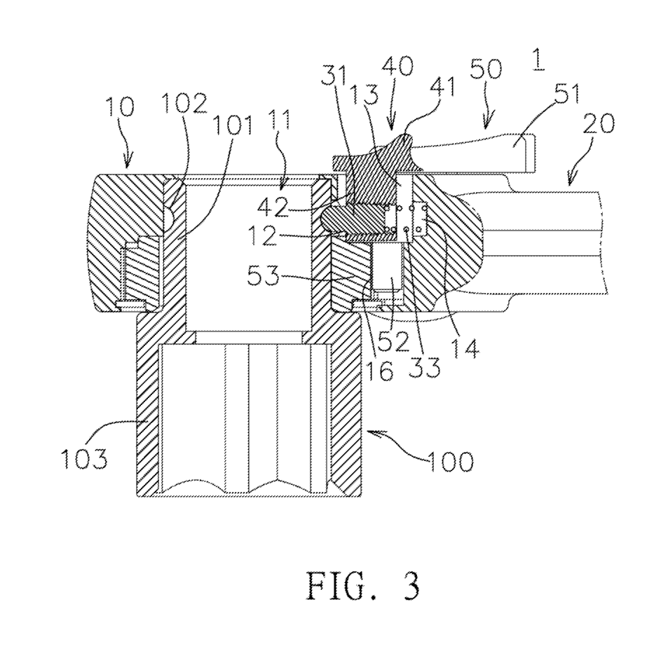

Please refer to FIG. 2 and FIG. 3, which illustrate a schematic view of a first preferred embodiment of a quick detachable wrench braking structure of the present invention. The quick detachable wrench has a wrench head 10, a wrench handle 20, an urging device 30, and an operation device 40. The wrench head 10 has a hollow operation accommodation room 11. The peripheral wall of the operation accommodation room 11 is consisting of arc surface, curve surface, straight surface, etc., but not limited thereto. An acting hole 12 is horizontally disposed in a rear peripheral wall of the operation accommodation room 11 and is along the wrench handle 20. A control hole 13 is vertically disposed behind the operation accommodation room 11. For the present embodiment, an extension direction of the control hole 13 and an extension direction of the wrench handle 20 are staggered. The control hole 13 is a long hole and is connected with the acting hole 12, or the acting hole 12 and the control hole 13 are vertically connected with each other. An urging hole 14 corresponding to the direction of the acting hole 12 is behind the control hole 13 and is along the wrench handle 20. The wrench handle 20 is connected with and behind the wrench head 10 for holding and applying forces.

The urging device 30 has an urging rod 31 and a spring 33 (flexible member). A front end of the urging rod 31 is an urging head 310, and the diameter of the urging head 310 is less than the diameter of the acting hole 12, so as to let the urging rod 31 be inserted into and act in the acting hole 12. A rear end of the urging rod 31 is a positioning section 32 that is a threaded section for the present embodiment. An operation device 40 has a pushing member 41 and an inserting rod 42 underneath. The inserting rod 42 is inserted into the control hole 13. A diameter of the inserting rod 42 is less than a length of the control hole 13, so that the inserting rod 42 is able to move back and forth in the control hole 13. The inserting rod 42 has a positioning hole 421 corresponding to the acting hole 12, that is, the positioning hole 421 and the control hole 13 are vertically connected with each other. For the present embodiment, the positioning hole 421 is a threaded hole.

While in assembly, the inserting rod 42 is inserted into the control hole 13, and the positioning section 32 of the urging rod 31 is fastened (tighten with screws) in the positioning hole 421. Hence, the urging rod 31 and the positioning hole 421 are tightly connected for continuous stable operations. The spring 33 is disposed in the positioning hole 421 in order to let the front end of the spring 33 urge the urging rod 31, and then the rear end of the spring 33 urges the urging hole 14, so that the urging head 310 of the urging rod 31 goes through the acting hole 12 to be in the operation accommodation room 11, as shown in FIG. 3. It is that the assembly is completed. Except aforesaid application, another application is to make the spring 33 urge onto the inserting rod 42 for providing the urging rod 31 a forward urging force.

While in use, a sleeve head 101 of a sleeve 100 (working piece to be rotated) is disposed into the operation accommodation room 11, and the sleeve head 101 has a positioning ring slot 102. An accommodation portion 103 is the lower portion of the sleeve 100 and is able to rotate a positioning working piece (not shown in figure, as screw head cap, nut, etc.

As shown in FIG. 3, while the pushing member 41 is at a front position of the wrench head 10, that is, the pushing member 14 is driven by the spring 33 and moves forward in the control hole 13. In the meantime, the front end (the urging head 310) of the urging rod 31 protrudes out from the acting hole 12 and urges the positioning ring slot 102 of the sleeve 100, in order to position the sleeve 100 (the sleeve head 101).

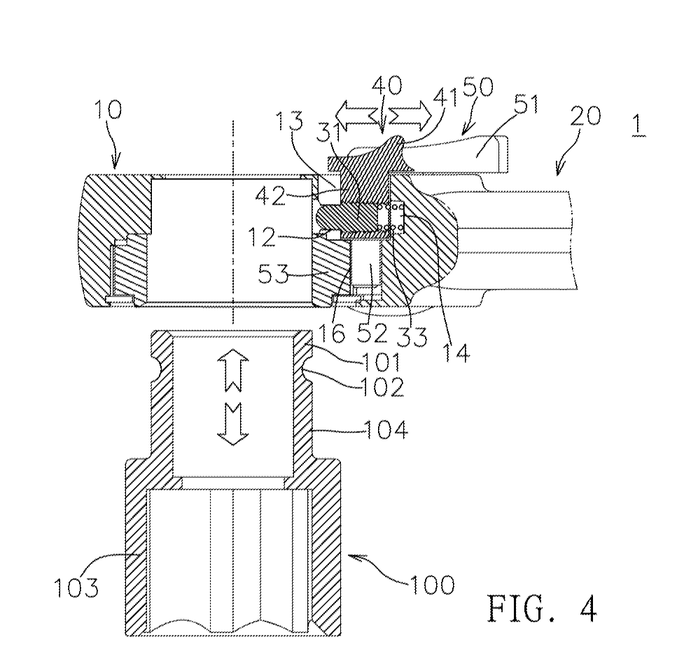

As shown in FIG. 4, for performing a detaching operation of the wrench head 10 and the sleeve 100, the pushing member 41 is moved backward to drive the inserting rod 42 and the urging rod 31 in order to take the urging rod 31 (the urging head 310) off from the positioning ring slot 102. Hence, the sleeve 100 (working piece to be rotated) is able to be fast and conveniently detached from the operation accommodation room 11, further to separate the sleeve 100 and the quick detachable wrench. Meanwhile, the spring 33 is in a state of compression. While releasing the pushing member 41, the pushing member 41 is pushed forward by the spring 33, so as to drive the urging rod 31 (the urging head 310) forward. Continuously let the wrench head 10 female-connect with the sleeve 100 by means of the operation accommodation room 11, the urging rod 31 (the urging head 310) is thus pushed backward, and then is urged by the spring 33 to move forward, so that the urging rod 31 (the urging head 310) urges the positioning ring slot 102 of the sleeve 100. Aforesaid operations are to position the sleeve 100 (the sleeve head 101) for rotating positioning working pieces.

It is to be noted that the link and combination of the urging rod 31 and the inserting rod 42 are precise and easy in order to meet not only the requirements of manufacturing and assembly, but also continuous stable operations without deformation and malfunction. So that life and quality are tremendously enlarged.

Further, for the first preferred embodiment, a pivoting slot 16 is disposed (at a rear end of the wrench head 10) around the wrench handle 20. An open slot 17 is disposed in a bottom edge of a rear peripheral wall of the operation accommodation room 11 and is along the wrench handle 20 (horizontal). The open slot 17 has a turning switch 50 that has a pulling member 51 above and a pulling rod 52 under the pulling member 51. The pulling rod 52 is pivotally disposed in the pivoting slot 16, the open slot 17 has a ratchet member 53 that is driven by the pulling rod 52 (the turning switch 50). In addition, the ratchet member 53 engages a ring tooth portion 104 of the sleeve 100 if the sleeve 100 is disposed in the operation accommodation room 11. Via the pulling member 51 (the turning switch 50), the direction of rotating the ring tooth portion 104 can be changed.

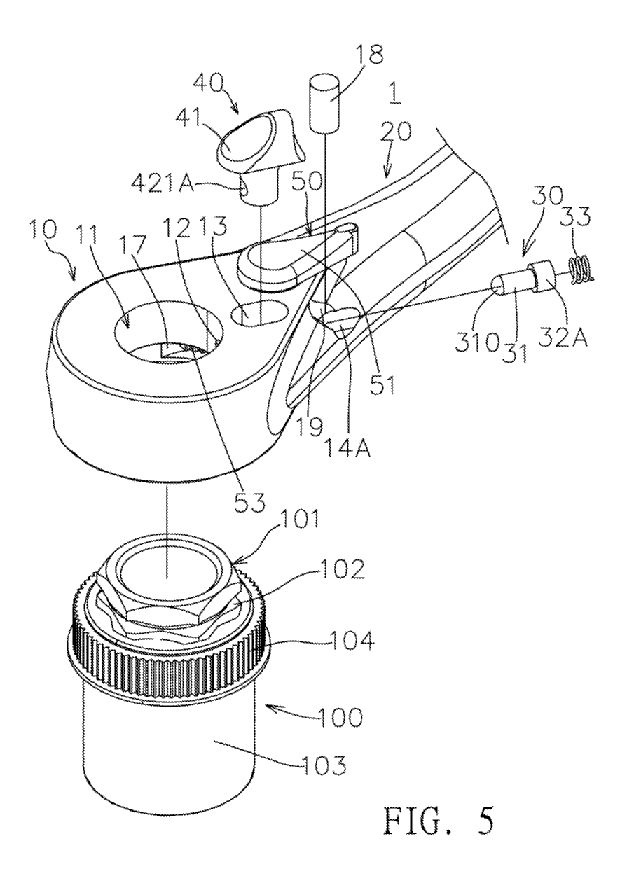

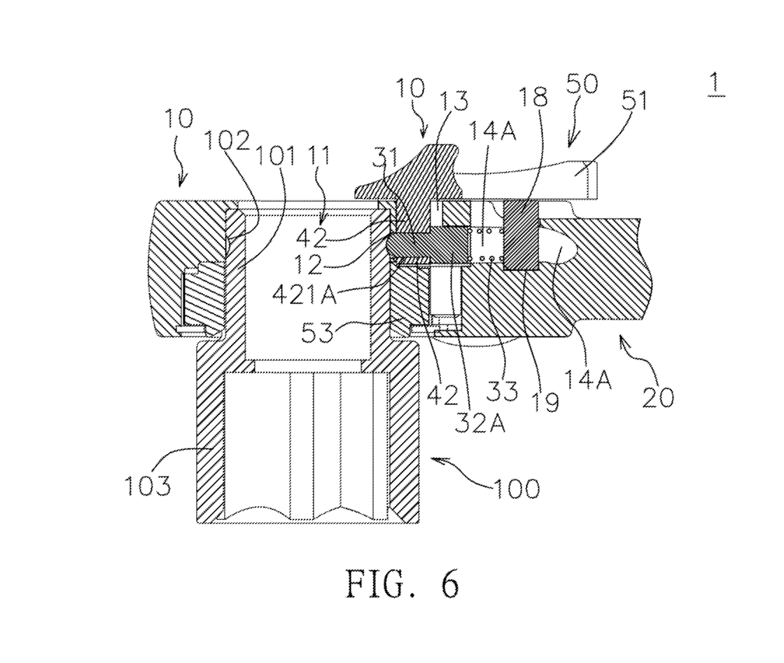

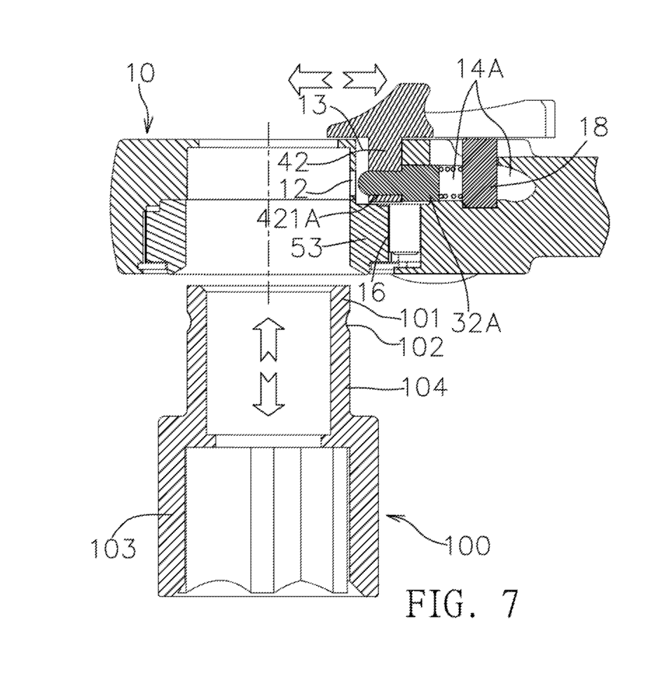

With reference to FIG. 5, FIG. 6 and FIG. 7, which illustrate a schematic view of a second preferred embodiment of the quick detachable wrench braking structure of the present invention. The differences between the first preferred embodiment and the second preferred embodiment are described below. An urging hole 14A backward penetrates the wrench head 10. An urging slot 19 for is vertically disposed in the rear end of the urging hole 14A, or is disposed in the rear end of the urging hole 14A at around 90 degrees. The urging slot 19 has an urging pillar 18 that is an urging member at the rear end of the urging hole 14A. A positioning hole 421A of the inserting rod 42 is a through hole with a smooth inner surface (not threaded hole). The diameter of the positioning section 32A (not threaded section) at the rear end of the urging rod 31 is enlarged. The urging rod 31 is inserted into the positioning hole 421A by way of tight fitting in order to let the inserting rod 42 drive the urging rod 31. The rear end of the urging rod (31) is a positioning section 32A that is in the urging hole 14A and is behind the inserting rod 42 (the positioning hole 421A), so that the positioning section 32A is able to move back and forth in the urging hole 14A. The spring 33 urges both the positioning section 32A and the urging pillar 18 in order to provide an urging force to the urging rod 31. As aforementioned, the quick detachable wrench 1 facilitates assembly.

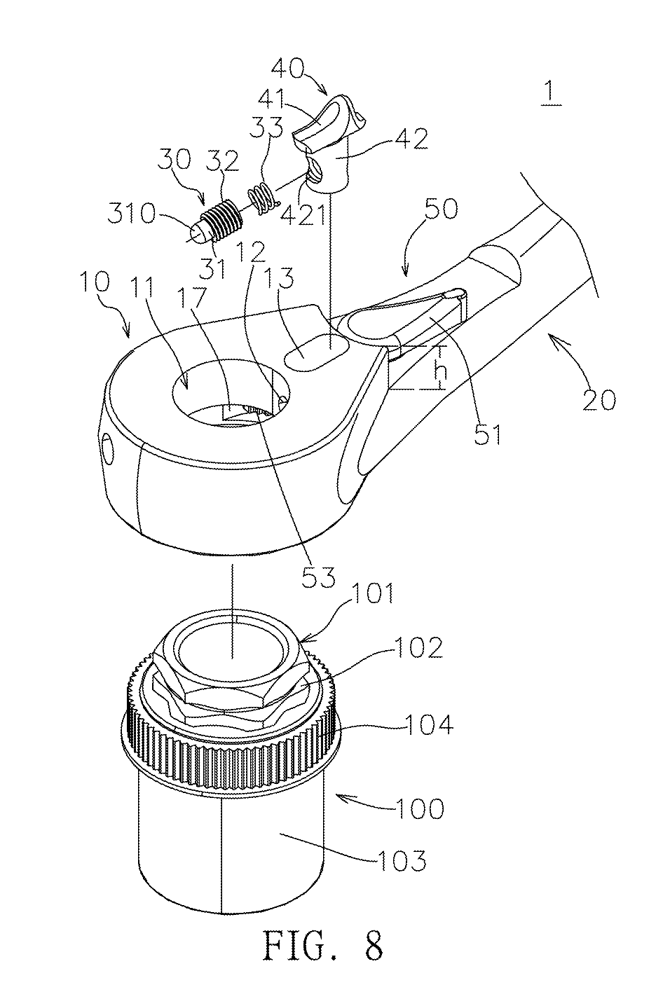

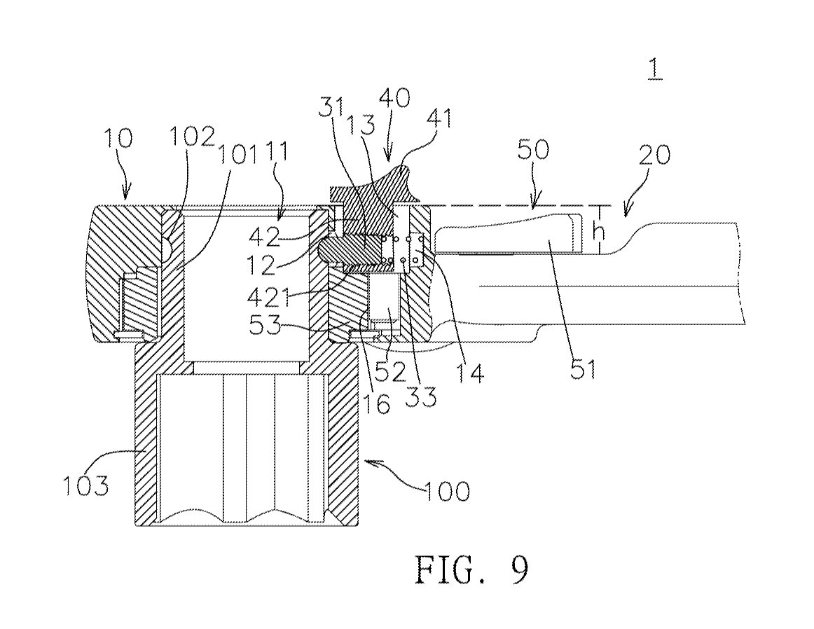

With reference to FIG. 8 and FIG. 9, which illustrate a schematic view of a third preferred embodiment of the quick detachable wrench braking structure of the present invention. The differences among the third preferred embodiment, the first preferred embodiment and the second preferred embodiment are described below. An extension direction of the control hole 13 and an extension direction of the wrench handle 20 are the same and tandem, or are parallel to each other and tandem, wherein the control hole 13 is a long hole. To avoid the interference of the operation device 40 and the turning switch 50, a ladder distance h is between them.

It is the same theory that the pushing member 41 stably driving the urging rod 31 in order to let the urging rod 31 move back and forth in the acting hole 12. Therefore, the sleeve 100 (working piece to be rotated) is capable of urging and position or fast detaching from the operation accommodation room 11.

Further, as to the first and second preferred embodiments, how to arrange the urging hole 14 and the spring 33, to fasten the inserting rod 42 and the urging rod 31, etc., there are many kinds of combinations and applications.

The quick detachable wrench braking structure has the feature of fast detaching from a working piece to be rotated, in order to facilitate operations and safety. Another feature is an automatic recover effect after pushing while in detaching the wrench from the working piece to be rotated. It is very convenient for next operation, and practicability and added value are both promoted. On the other hand, the easy linking structure facilitates manufacturing and assembly for better economic effect; for operations, the braking structure prevents parts being loosened, shaken or broken, so as to tremendously increase stability, operation certainty, life, and quality.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A quick detachable wrench braking structure having a quick detachable wrench, the quick detachable wrench comprising:
a wrench head, having an operation accommodation room, an acting hole being horizontally disposed in a rear peripheral wall of the operation accommodation room, a control hole being vertically disposed behind the operation accommodation room and being connected with the acting hole;
a wrench handle, being connected with and being behind the wrench head;
an operation device, having a pushing member and an inserting rod underneath, the inserting rod being inserted into the control hole, a diameter of the inserting rod being less than a length of the control hole, the inserting rod having a positioning hole corresponding to the acting hole; and
an urging device, having an urging rod and a flexible member, the urging rod being firmly inserted into the positioning hole, a front end of the urging rod being an urging head corresponding to the acting hole, the flexible member being in the control hole and being behind the urging rod in order to provide an urging force to the urging rod or the inserting rod.

2. The quick detachable wrench braking structure according to claim 1, the control hole is a long hole.

3. The quick detachable wrench braking structure according to claim 1, wherein an urging hole for disposing the flexible member is behind the control hole and is along the wrench handle.

4. The quick detachable wrench braking structure according to claim 3, wherein the flexible member is in the positioning hole, a front end of the flexible member urging the urging rod, a rear end of the flexible member urging the urging hole.

5. The quick detachable wrench braking structure according to claim 1, wherein a rear end of the urging rod is a positioning section that is a threaded section, the positioning hole being a threaded hole.

6. The quick detachable wrench braking structure according to claim 1, wherein a rear end of the wrench head is disposed a pivoting slot, an open slot being disposed in a bottom edge of a rear peripheral wall of the operation accommodation room and being along the wrench handle, the open slot having a turning switch that has a pulling member above and a pulling rod under the pulling member, the pulling rod being pivotally disposed in the pivoting slot, the open slot having a ratchet member that is driven by the pulling rod.

7. The quick detachable wrench braking structure according to claim 3, wherein the urging hole backwardly penetrates through the wrench head, a urging pillar being at a rear end of the urging hole.

8. The quick detachable wrench braking structure according to claim 7, wherein an urging slot for accommodating the urging pillar is vertically disposed in the rear end of the urging hole, or is disposed in the rear end of the urging hole at around 90 degrees.

9. The quick detachable wrench braking structure according to claim 3, wherein the urging rod is inserted into the positioning hole by way of tight fitting, a rear end of the urging rod is a positioning section that is in the urging hole.

10. The quick detachable wrench braking structure according to claim 9, wherein a diameter of the positioning section is enlarged.

11. The quick detachable wrench braking structure according to claim 1, wherein an extension direction of the control hole and an extension direction of the wrench handle are staggered.

12. The quick detachable wrench braking structure according to claim 1, wherein an extension direction of the control hole and an extension direction of the wrench handle are the same and tandem, or are parallel to each other and tandem.

13. The quick detachable wrench braking structure according to claim 6, wherein a ladder distance is between the operation device and the turning switch.
